(19) United States
(12) Patent Application Publication
(10) Pub. No.: US 2020/0096886 A1
(43) Pub. Date: Mar. 26, 2020

(54) ELECTROPHOTOGRAPHIC PHOTORECEPTOR, PROCESS CARTRIDGE, AND IMAGE FORMING APPARATUS

(71) Applicant: FUJI XEROX CO., LTD., Tokyo (JP)

(72) Inventors: Takaakira SASAKI, Kanagawa (JP); Takayuki YAMASHITA, Kanagawa (JP)

(73) Assignee: FUJI XEROX CO., LTD., Tokyo (JP)

(21) Appl. No.: 16/262,943

(22) Filed: Jan. 31, 2019

(30) Foreign Application Priority Data
Sep. 26, 2018 (JP) 2018-180855

(51) Int. Cl. G03G 5/14; G03G 21/18; G03G 15/02; G03G 5/10

(52) U.S. Cl. CPC G03G 5/144; G03G 21/1803; G03G 5/142; G03G 5/10; G03G 15/0266

(57) ABSTRACT

An electrophotographic photoreceptor includes a conductive substrate having a surface, an undercoat layer disposed on the surface of the conductive substrate, and a photosensitive layer on the undercoat layer. A maximum height waviness of a waviness profile of the surface of the conductive substrate on which the undercoat layer is disposed is 1.4 μm or less, and the undercoat layer contains a binder resin and has a thickness non-uniformity of 0.4 μm or less.

### CROSS-REFERENCE TO RELATED APPLICATIONS

This application is based on and claims priority under 35 USC 119 from Japanese Patent Application No. 2018-180855 filed Sep. 26, 2018.

### BACKGROUND

### (i) Technical Field

The present disclosure relates to an electrophotographic photoreceptor, a process cartridge, and an image forming apparatus.

### (ii) Related Art

Japanese Unexamined Patent Application Publication No. 2012-203023 discloses “an electrophotographic photoreceptor including a conductive substrate and at least a photosensitive layer and a surface layer on the conductive substrate, wherein an arithmetic mean waviness Wa is 0.08 μm to 0.20 μm and a waviness profile element mean width WSm is 3.0 mm to 6.0 mm in a waviness profile obtained by measuring an axis-direction surface geometry of the electrophotographic photoreceptor by a profile method, blocking roughness components with a kc profile filter at a cut-off value of 2.5 mm, and blocking wavelength components longer than the waviness with a Xf profile filter at a cut-off value of 8.0 mm”.

Japanese Unexamined Patent Application Publication No. 2017-203796 discloses “an image forming apparatus including: an image carrier that includes an electrically conductive cylindrical support and a single-layer-structure photosensitive layer that contains a charge generating material and a charge transporting material stacked on a surface of the support; a charging member disposed in contact with or near a surface of the image carrier to charge the photosensitive layer by application of a charging bias; an exposing device that forms an electrostatic latent image on a surface of the photosensitive layer by irradiating the photosensitive layer charged by the charging member with light; a developing device that develops the electrostatic latent image formed on the surface of the photosensitive layer by the exposing device; and a cleaning member that is disposed to contact the surface of the image carrier to clean the surface of the image carrier, wherein a maximum height Ry of irregularities on the surface of the support in a longitudinal direction is 0.5 μm or more and 2.0 μm or less, and a mean spacing Sm of the irregularities is 5 μm or more and 200 μm or less”.

### SUMMARY

An electrophotographic photoreceptor of related art has a tendency such that formation of a multiple-color image in which two or more colors are superimposed causes an afterimage phenomenon in which the history of this previous image remains (hereinafter this phenomenon is referred to as “multiple-color ghost”).

Aspects of non-limiting embodiments of the present disclosure relate to an electrophotographic photoreceptor with which occurrence of the multiple-color ghost is suppressed compared to an electrophotographic photoreceptor that includes a conductive substrate in which the maximum height waviness of the waviness profile of the surface on which the undercoat layer is formed is more than 1.4 μm and an undercoat layer having a thickness non-uniformity exceeding 0.4 μm.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an electrophotographic photoreceptor including: a conductive substrate having a surface; an undercoat layer disposed on the surface of the conductive substrate; and a photosensitive layer on the undercoat layer, in which a maximum height waviness of a waviness profile of the surface of the conductive substrate on which the undercoat layer is disposed is 1.4 μm or less, and the undercoat layer contains a binder resin and has a thickness non-uniformity of 0.4 μm or less.

### BRIEF DESCRIPTION OF THE DRAWINGS

Exemplary embodiments of the present disclosure will be described in detail based on the following figures, wherein:

FIG. 1 is a schematic diagram illustrating one example of an image forming apparatus according to an exemplary embodiment;

FIG. 2 is a schematic diagram illustrating another example of the image forming apparatus according to the exemplary embodiment; and

FIG. 3 is a schematic cross-sectional view of one example of the layer structure of an electrophotographic photoreceptor of an exemplary embodiment.

### DETAILED DESCRIPTION

The exemplary embodiments of the present disclosure will now be described.

### Electrophotographic Photoreceptor

An electrophotographic photoreceptor according to an exemplary embodiment includes a conductive substrate, an undercoat layer disposed on a surface of the conductive substrate, and a photosensitive layer on the undercoat layer, in which a maximum height waviness of a waviness profile of the surface of the conductive substrate on which the undercoat layer is formed is 1.4 μm or less, and the undercoat layer contains a binder resin and has a thickness non-uniformity of 0.4 μm or less.

Electrophotographic image forming apparatuses in recent years have faced growing demand for improved performance, such as higher speed and higher image quality, as well as environmental load reduction, size reduction, and lower prices. To meet the demand, an increasing number of image forming apparatuses are employing, as the charging units, contact-charging-type charging units that apply DC voltages. Moreover, a system that does not include a charge erasing unit that erases potential differences, which are generated during transfer of the toner image onto a transfer-receiving member, on the surface of the electrophotographic photoreceptor after a toner image is transferred onto a transfer-receiving member by a transfer unit and before the surface of an electrophotographic photoreceptor is charged by a charging unit is increasingly employed.

In an electrophotographic image forming apparatus, application of a reverse bias in the transfer step causes electrostatic force that acts from the photoreceptor surface toward a transfer unit works on the toner image, and the toner image on the photoreceptor surface is transferred onto a transfer-receiving member. In the photoreceptor surface after the toner image transfer, differences in residual potential occur between regions where the toner image has been present and regions where the toner image has not been present.

When a multiple-color image is formed by using an image forming apparatus equipped with multiple image forming units disposed side by side along the transfer-receiving member travelling direction (hereinafter this apparatus may be referred to as a “tandem-system image forming apparatus”), after the transfer, the differences between the residual potential in regions where the multiple-color toner image has been present and that in regions where the multiple-color toner image has not been present becomes more notable due to the thickness of the superimposed toner image.

When an image is formed by using an image forming apparatus not having a charge erasing unit after the transfer unit has transferred the toner image onto a transfer-receiving member and before the charging unit charges the surface of the electrophotographic photoreceptor, the photoreceptor surface is charged in the next cycle while the potential differences are still present on the photoreceptor surface as mentioned above. At this stage, when the photoreceptor surface is charged by a charging unit of a type that applies a DC voltage, discharging toward the photoreceptor surface in portions corresponding to the portion where the multiple-color toner image before transfer had been present becomes difficult, and potential non-uniformity occurs on the photoreceptor surface. Thus, multiple-color ghost is generated in a blank portion where the multiple-color toner image is absent and an image portion where an image having a low image density (hereinafter this image is referred to as a “halftone mage”) exists.

When an image is formed of one color, after the transfer, potential differences are generated between regions in the photoreceptor surface where the one-color toner image has been present and regions where the toner image has not been present, but such potential differences rarely cause ghosting. When an AC voltage is applied to the photoreceptor surface, the potential difference in the photoreceptor surface is evened out, and the ghost rarely occurs.

In contrast, an image forming apparatus equipped with the electrophotographic photoreceptor of this exemplary embodiment has the above-described structure, and thus can suppress generation of the multiple-color ghost when forming a multiple-color image. The reason for this is not clear, but is presumed to be as follows.

In the electrophotographic photoreceptor of this exemplary embodiment, the surface of the conductive substrate on which the undercoat layer is formed (hereinafter this surface may be simply referred to as the “surface of the conductive substrate”) has a waviness profile with a maximum height waviness of 1.4 μm or less. The surface of the conductive substrate having a maximum height waviness of 1.4 μm or less is a surface that has a small surface texture in which the irregularities on the surface of the conductive substrate are small. Thus, when an undercoat layer is formed on this conductive substrate, a surface of the undercoat layer on which a photosensitive layer is to be formed (hereinafter this surface may be simply referred to as the “surface of the undercoat layer”) tends to have a thickness non-uniformity of 0.4 μm or less. When the thickness non-uniformity of the surface of the undercoat layer is 0.4 μm or less, degradation of the charge uniformity in the photosensitive layer tends to be suppressed. More specifically, in the photoreceptor surface after the transfer of the multiple-color toner image and before charging, formation of the regions between which potential differences occur tends to be suppressed. Presumably as a result, discharging toward the photoreceptor surface under application of a DC voltage is stabilized, and generation of the multiple-color ghost is suppressed when a multiple-color image is formed.

Next, the electrophotographic photoreceptor of this exemplary embodiment is described.

In the description below, the layer structure of the electrophotographic photoreceptor of this exemplary embodiment is described.

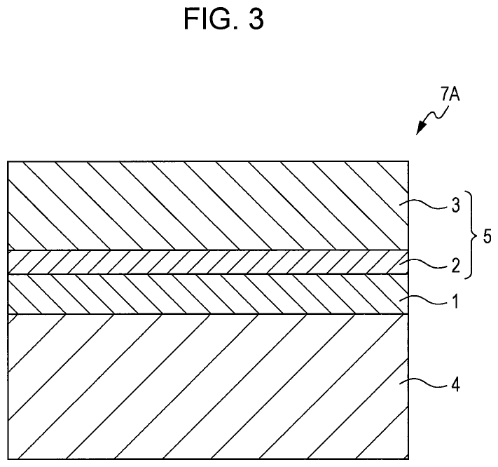

FIG. 3 is a schematic partial cross-sectional view of one example of the layer structure of an electrophotographic photoreceptor of this exemplary embodiment. An electrophotographic photoreceptor 7A illustrated in FIG. 3 has a structure in which an undercoat layer 1, a charge generating layer 2, and a charge transporting layer 3 are stacked in this order on a conductive substrate 4. The charge generating layer 2 and the charge transporting layer 3 constitute a photosensitive layer 5. The electrophotographic photoreceptor 7A may have other layers as needed. Examples of other layers include a protective layer formed on an outer circumferential surface of the charge transporting layer 3. The electrophotographic photoreceptor of this exemplary embodiment is not limited to the structure illustrated in FIG. 3, and the photosensitive layer may be a single-layer-type photosensitive layer.

In the description below, the respective layers of the electrophotographic photoreceptor of this exemplary embodiment are described in detail. In the description below, the reference signs are omitted.

### Conductive Substrate

The electrophotographic photoreceptor includes a conductive substrate.

The conductive substrate has a surface on which an undercoat layer is formed (hereinafter this surface may be simply referred to as the “surface of the conductive substrate”), and the maximum height waviness Wz of a waviness profile of this surface is 1.4 μm or less, may be 1.35 μm or less, may be 1.3 μm or less, or may be 1.25 μm or less.

When the maximum height waviness Wz of the waviness profile of the surface of the conductive substrate is 1.4 μm or less, occurrence of the multiple-color ghost is suppressed.

The maximum height waviness Wz is the maximum height of a waviness profile of a surface of the conductive substrate on which the undercoat layer is formed, and is a sum of a maximum peak height Zp and a maximum valley depth Zv of a profile at a sampling length. The maximum height waviness is a value measured in accordance with JIS-B 0601 (2001). In the exemplary embodiment, measurement is conducted by using a surface roughness/profile meter Surfcom (produced by TOKYO SEIMITSU CO., LTD.). Specifically, the surface geometry of the conductive substrate in the axis direction is measured by a profile method, roughness components are blocked with a Xc profile filter at a cut-off value of 2.5 mm, and wavelength components longer than the waviness are blocked with a Xf profile filter at a cut-off value of 8.0 mm so as to measure the filtered wave center waviness (filtered wave waviness profile). The maximum height waviness Wz is determined by measuring the waviness at multiple positions on the surface of the conductive substrate and then calculating the average.

Regarding the conductive substrate, the lower limit of the mean width WSm of the waviness profile of the surface on which the undercoat layer is formed may be 0.5 mm or more, 0.6 mm or more, or 0.7 mm or more.

When the lower limit of the mean width WSm of the waviness profile of the surface of the conductive substrate is 0.5 mm or more, occurrence of the multiple-color ghost tends to be suppressed.

Regarding the conductive substrate, the upper limit of the mean width of the waviness profile of the surface on which the undercoat layer is formed may be 30 mm or less, 25 mm or less, or 20 mm or less.

The mean width of the waviness profile refers to the mean width of the waviness profile along the axis direction on the outer circumferential surface of the conductive substrate measured in accordance with JIS B 0601 (2001). The primary profile along the axis direction on the outer circumferential surface of the conductive substrate is measured from one end to the other end of the conductive substrate in the axis direction by using a surface roughness/profile meter (Surfcom 1400 produced by TOKYO SEIMITSU CO. LTD.). The obtained primary profile is analyzed at an evaluation length ln of 8 mm, a cut-off value λc of 0.8 mm, and a cut-off value λf of 2.5 μm to calculate the mean width WSm of the waviness profile.

An example of the method for adjusting the maximum height waviness and the mean width of the waviness profile of the surface of the conductive substrate is to cut the conductive substrate.

Examples of the conductive substrate include metal plates, metal drums, and metal belts that contain metals (aluminum, copper, zinc, chromium, nickel, molybdenum, vanadium, indium, gold, platinum, etc.) or alloys (stainless steel etc.). Other examples of the conductive substrate include paper sheets, resin films, and belts coated, vapor-deposited, or laminated with conductive compounds (for example, conductive polymers and indium oxide), metals (for example, aluminum, palladium, and gold), or alloys. The term “conductive” means having a volume resistivity of less than 10¹³ Ωcm.

The conductive substrate is, for example, a cylindrical hollow member and may be formed of a metal. Examples of the metal that constitutes the conductive substrate include pure metals such as aluminum, iron, and copper, and alloys such as stainless steel and aluminum alloys. The metal that constitutes the conductive substrate may be a metal that contains aluminum from the viewpoint of light-weightiness and excellent workability, and may be pure aluminum or an aluminum alloy. The aluminum alloy may be any alloy containing aluminum as a main component, and examples aluminum alloys include those that contain, in addition to aluminum, Si, Fe, Cu, Mn, Mg, Cr, Zn, or Ti. The “main component” here refers to an element that has the highest content (on a mass basis) among all of the elements contained in the alloy. From the viewpoint of workability, the metal that constitutes the conductive substrate may be a metal having an aluminum content (mass ratio) of 90.0% or more, 95.0% or more, or 99.0% or more.

The conductive substrate is produced by, for example, a known forming technique such as drawing, impact pressing, ironing, or cutting. The conductive substrate may be produced by cutting from the viewpoint of adjusting the maximum height waviness and the mean width of the waviness profile of the surface of the conductive substrate to be within the above-described specified ranges.

The surface of the conductive substrate may be subjected to a known surface treatment, such as anodizing, pickling, or a Boehmite treatment.

The surface of the conductive substrate may be roughened to a center-line average roughness Ra of 0.04 μm or more and 0.5 μm or less in order to suppress interference fringes that occur when the electrophotographic photoreceptor used in a laser printer is irradiated with a laser beam. When incoherent light is used as a light source, there is no need to roughen the surface to prevent interference fringes, but roughening the surface suppresses generation of defects due to irregularities on the surface of the conductive substrate and thus is desirable for extending the lifetime.

Examples of the surface roughening method include a wet honing method with which an abrasive suspended in water is sprayed onto a conductive substrate, a centerless grinding with which a conductive substrate is pressed against a rotating grinding stone to perform continuous grinding, and an anodization treatment.

Another example of the surface roughening method does not involve roughening the surface of a conductive substrate but involves dispersing a conductive or semi-conductive powder in a resin and forming a layer of the resin on a surface of a conductive substrate so as to create a rough surface by the particles dispersed in the layer.

The surface roughening treatment by anodization involves forming an oxide film on the surface of a conductive substrate by anodization by using a metal (for example, aluminum) conductive substrate as the anode in an electrolyte solution. Examples of the electrolyte solution include a sulfuric acid solution and an oxalic acid solution. However, a porous anodization film formed by anodization is chemically active as is, is prone to contamination, and has resistivity that significantly varies depending on the environment. Thus, a pore-sealing treatment may be performed on the porous anodization film so as to seal fine pores in the oxide film by volume expansion caused by hydrating reaction in pressurized steam or boiling water (a metal salt such as a nickel salt may be added) so that the oxide is converted into a more stable hydrous oxide.

The thickness of the anodization film may be, for example, 0.3 μm or more and 15 μm or less. When the thickness is within this range, a barrier property against injection tends to be exhibited, and the increase in residual potential caused by repeated use tends to be suppressed.

The thickness of the conductive substrate may be 0.2 mm or more and 2.0 mm or less, may be 0.4 mm or more and 1.6 mm or less, or may be 0.7 mm or more and 1.2 mm or less.

The thickness of the conductive substrate is measured by removing the layers (such as a photosensitive layer) on the outer circumferential surface of the conductive substrate in the electrophotographic photoreceptor with a cutter or the like or removing these layers by dissolving in a solvent or the like. The thickness of the conductive substrate is measured with a micrometer. For example, when the conductive substrate is a cylindrical hollow member, the thickness can be measured at 10 points in the axis direction×8 points in the circumferential direction, from which the average thereof is determined. In order to measure the thickness more accurately, an ultrasonic precision corrosion thickness meter (product name: 38DL PLUS) produced by OLYMPUS CORPORATION is used.

The conductive substrate may be subjected to a treatment with an acidic treatment solution or a Boehmite treatment.

The treatment with an acidic treatment solution is, for example, conducted as follows. First, an acidic treatment solution containing phosphoric acid, chromic acid, and hydrofluoric acid is prepared. The blend ratios of phosphoric acid, chromic acid, and hydrofluoric acid in the acidic treatment solution may be, for example, in the range of 10 mass % or more and 11 mass % or less for phosphoric acid, in the range of 3 mass % or more and 5 mass % or less for chromic acid, and in the range of 0.5 mass % or more and 2 mass % or less for hydrofluoric acid; and the total concentration of these acids may be in the range of 13.5 mass % or more and 18 mass % or less. The treatment temperature may be, for example, 42° C. or higher and 48° C. or lower. The thickness of the film may be 0.3 μm or more and 15 μm or less.

The Boehmite treatment is conducted by immersing a conductive substrate in pure water at 90° C. or higher and 100° C. or lower for 5 to 60 minutes or by bringing a conductive substrate into contact with pressurized steam at 90° C. or higher and 120° C. or lower for 5 to 60 minutes. The thickness of the film may be 0.1 μm or more and 5 μm or less. The Boehmite-treated body may be further anodized by using an electrolyte solution, such as adipic acid, boric acid, a borate salt, a phosphate salt, a phthalate salt, a maleate salt, a benzoate salt, a tartrate salt, or a citrate salt, that has low film-dissolving power.

Undercoat Layer

The electrophotographic photoreceptor includes an undercoat layer on the conductive substrate.

The undercoat layer contains a binder resin and has a thickness non-uniformity of 0.4 μm or less. The undercoat layer may further contain metal oxide particles, an electron-accepting compound, and other additives.

### Binder Resin

The undercoat layer contains a binder resin. The undercoat layer may be a layer formed of a cured film (including a crosslinked film) prepared by curing a binder resin.

Examples of the binder resin used in the undercoat layer include thermosetting polymer compounds such as polyimide, guanamine resins, urethane resins, epoxy resins, phenolic resins, urea resins, melamine resins, unsaturated polyester resins, diallyl phthalate resins, alkyd resins, polyaminobismaleimide, furan resins, and phenol-formaldehyde resins.

Among these, the binder resin may be at least one selected from guanamine resins, polyimide, urethane resins, epoxy resins, phenolic resins, urea resins, and melamine resins, or may be at least one selected from phenolic resins, melamine resins, guanamine resins, and urethane resins. When two or more of these binder resins are used in combination, the mixing ratios may be set as necessary.

The binder resin may use a curing agent, such as a polyfunctional epoxy compound or a polyfunctional isocyanate compound.

Examples of the polyfunctional epoxy compound that can be used include polyfunctional epoxy derivatives such as diglycidyl ether compounds, triglycidyl ether compounds, and tetraglycidyl ether compounds, and haloepoxy compounds. Specific examples thereof include glycidyl ether compounds of polyhydric alcohols such as ethylene glycol diglycidyl ether, polyethylene glycol diglycidyl ether, propylene glycol diglycidyl ether, polypropylene glycol diglycidyl ether, glyceryl diglycidyl ether, and glyceryl triglycidyl ether; glycidyl ether compounds of aromatic polyhydric phenols, such as bisphenol A diglycidyl ether; and haloepoxy compounds such as epichlorohydrin, epibromohydrin, and β-methylepichlorohydrin.

The polyfunctional isocyanate compound may have three or more isocyanate groups, and specific examples thereof include polyisocyanate monomers such as 1,3,6-hexamethylene triisocyanate, lysine ester triisocyanate, 1,6,11-undecane triisocyanate, 1,8-isocyanate-4-isocyanatomethyloctane, triphenylmethane triisocyanate, and tris(isocyanatophenyl) thiophosphate. From the viewpoint of film formation properties, crack generation properties, and handling ease of the crosslinked film obtained as a final product, modified products, such as derivatives and prepolymers obtained from polyisocyanate monomers, may be used among the compounds having three or more isocyanate groups.

Examples thereof include a urethane modified product obtained by modifying a polyol with the trifunctional isocyanate compound in excess, a biuret modified product obtained by modifying a compound having a urea bond with an isocyanate compound, and an allophanate modified product obtained by adding isocyanates to a urethane group. Other examples include isocyanurate modified products and carbodiimide modified products.

The total binder resin content in the exemplary embodiment relative to the undercoat layer may be 30 mass % or more and 50 mass % or less or may be 35 mass % or more and 45 mass % or less.

### Metal Oxide Particles

The undercoat layer may further contain metal oxide particles.

An example of the metal oxide particles is inorganic particles having a powder resistance (volume resistivity) of 10² Ωcm or more and 10 μcm or less. Examples of the metal oxide particles having this resistance value include metal oxide particles such as zinc oxide particles, titanium oxide particles, tin oxide particles, and zirconium oxide particles.

The undercoat layer may contain at least one type of metal oxide particles selected from zinc oxide particles, titanium oxide particles, and tin oxide particles from the viewpoint of suppressing occurrence of the multiple-color ghost.

The specific surface area of the metal oxide particles measured by the BET method may be, for example, 10 m²/g or more.

The volume-average particle diameter of the metal oxide particles may be, for example, 50 nm or more and 2000 nm or less (or may be 60 nm or more and 1000 nm or less).

The amount of the metal oxide particles contained relative to the binder resin may be, for example, 10 mass % or more and 80 mass % or less, or may be 40 mass % or more and 80 mass % or less.

The metal oxide particles may be surface-treated. A mixture of two or more metal oxide particles subjected to different surface treatments or having different particle diameters may be used.

Examples of the surface treatment agent include a silane coupling agent, a titanate-based coupling agent, an aluminum-based coupling agent, and a surfactant. In particular, a silane coupling agent may be used, and an amino-group-containing silane coupling agent may be used.

Examples of the amino-group-containing silane coupling agent include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

Two or more silane coupling agents may be mixed and used. For example, an amino-group-containing silane coupling agent may be used in combination with an additional silane coupling agent. Examples of this additional silane coupling agent include, but are not limited to, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxy silane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment method that uses a surface treatment agent may be any known method, for example, may be a dry method or a wet method.

The treatment amount of the surface treatment agent may be, for example, 0.5 mass % or more and 10 mass % or less relative to the metal oxide particles.

The amount of the metal oxide particles contained relative to the undercoat layer may be 10 mass % or more and 80 mass % or less, may be 40 mass % or more and 80 mass % or less, or may be 60 mass % or more and 80 mass % or less from the viewpoint of suppressing occurrence of the multiple-color ghost.

Electron-Accepting Compound

The electron-accepting compound may be dispersed in the undercoat layer along with the metal oxide particles, or may be attached to the surfaces of the metal oxide particles. When the electron-accepting compound is contained while attaching to the surfaces of the metal oxide particles, the electron-accepting compound may be a material that chemically reacts with the surfaces of the metal oxide particles or a material that adsorbs to the surfaces of the metal oxide particles, and the electron-accepting compound can be selectively present on the surfaces of the metal oxide particles.

Examples of the electron-accepting compound include electron-accepting compounds having skeletons such as a quinone skeleton, an anthraquinone skeleton, a coumarin skeleton, a phthalocyanine skeleton, a triphenylmethane skeleton, an anthocyanin skeleton, a flavone skeleton, a fullerene skeleton, a ruthenium complex skeleton, a xanthene skeleton, a benzoxazine skeleton, and a porphyrin skeleton.

The electron-accepting compound may be a compound in which such a skeleton is substituted with a substituent such as an acidic group (for example, a hydroxyl group, a carboxyl group, or a sulfonyl group), an aryl group, or an amino group.

In particular, from the viewpoint of adjusting the electrostatic capacitance of the undercoat layer per unit area to be within the range described above, the electron-accepting compound may be an electron-accepting compound having an anthraquinone skeleton or may be an electron-accepting compound having a hydroxyanthraquinone skeleton (an anthraquinone skeleton having a hydroxyl group) in particular.

Specific examples of the electron-accepting compound having a hydroxyanthraquinone skeleton include compounds represented by general formula (1) below.

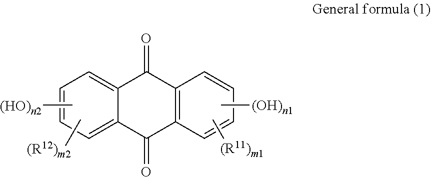

In general formula (1), n1 and n2 each independently represent an integer of 0 or more and 3 or less. However, at least one of n1 and n2 represents an integer of 1 or more and 3 or less (in other words, n1 and n2 do not simultaneously represent 0). In addition, m1 and m2 each independently represent an integer of 0 or 1. R¹¹ and R¹² each independently represent an alkyl group having 1 to 10 carbon atoms or an alkoxy group having 1 to 10 carbon atoms.

The electron-accepting compound may be a compound represented by general formula (2) below.

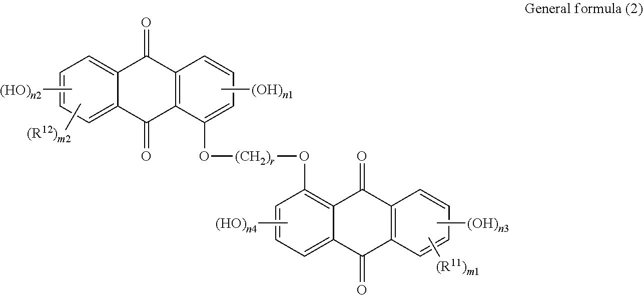

In general formula (2), n1, n2, n3, and n4 each independently represent an integer of 0 or more and 3 or less. In addition, m1 and m2 each independently represent an integer of 0 or 1. However, at least one of n1 and n2 represents an integer of 1 or more and 3 or less (in other words, n1 and n2 do not simultaneously represent 0). Moreover, at least one of n3 and n4 represents an integer of 1 or more and 3 or less (in other words, n3 and n4 do not simultaneously represent 0). Furthermore, r represents an integer of 2 or more and 10 or less. R¹¹ and R¹² each independently represent an alkyl group having 1 to 10 carbon atoms or an alkoxy group having 1 to 10 carbon atoms.

The alkyl groups having 1 to 10 carbon atoms represented by R¹¹ and R¹² in general formulae (1) and (2) may be linear or branched, and examples thereof include a methyl group, an ethyl group, a propyl group, and an isopropyl group. The alkyl group having 1 to 10 carbon atoms may be an alkyl group having 1 to 8 carbon atoms or an alkyl group having 1 to 6 carbon atoms.

The alkoxy groups (alkoxyl groups) having 1 to 10 carbon atoms represented by R¹¹ and R¹² may be linear or branched, and examples thereof include a methoxy group, an ethoxy group, a propoxy group, and an isopropoxy group. The alkoxy group having 1 to 10 carbon atoms may be an alkoxy group having 1 to 8 carbon atoms or an alkoxy group having 1 to 6 carbon atoms.

Non-limiting specific examples of the electron-accepting compound are as follows.

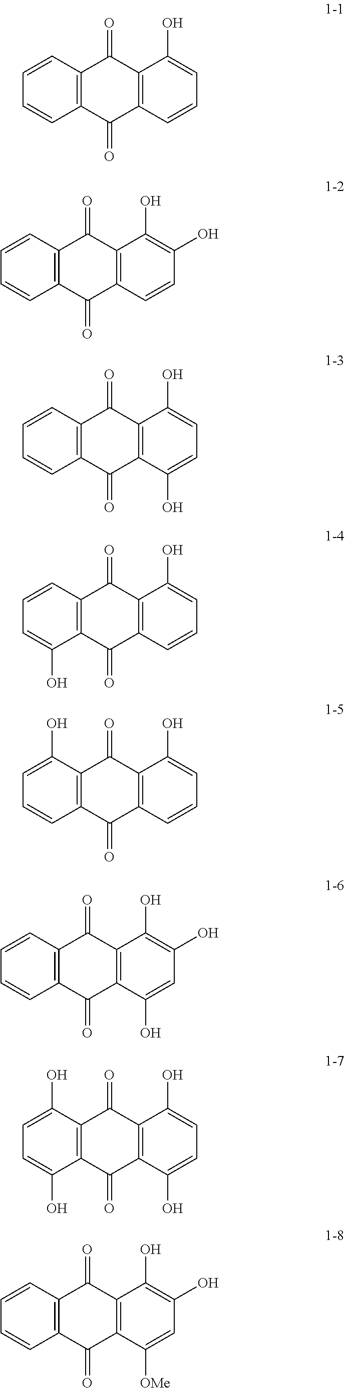

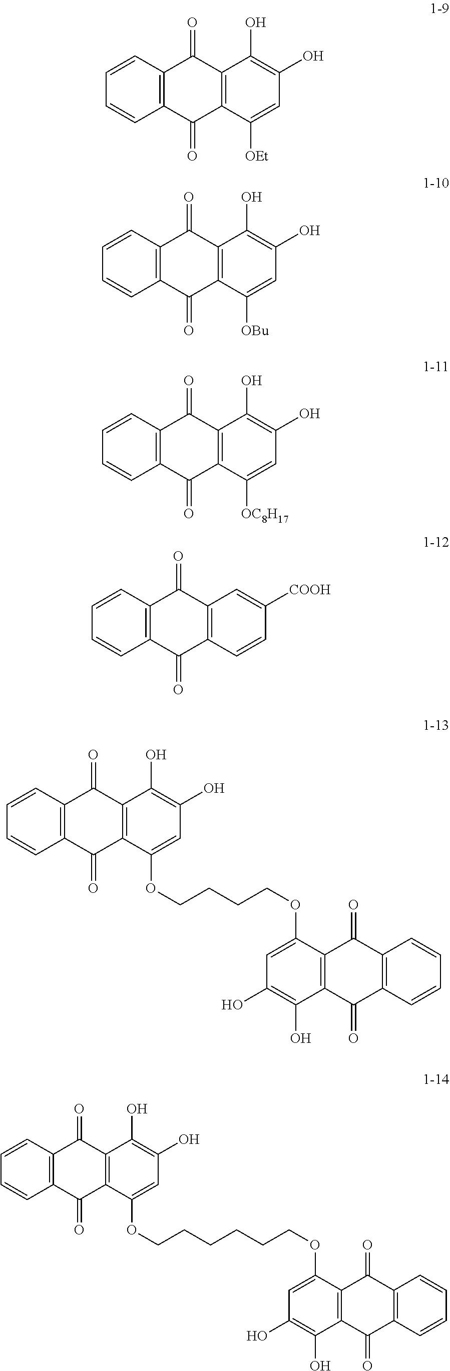

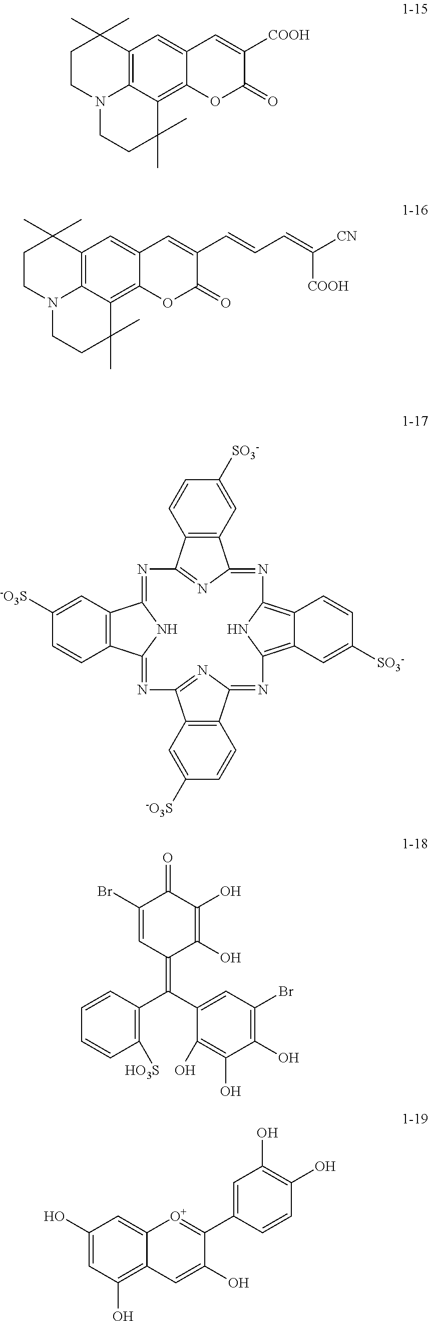

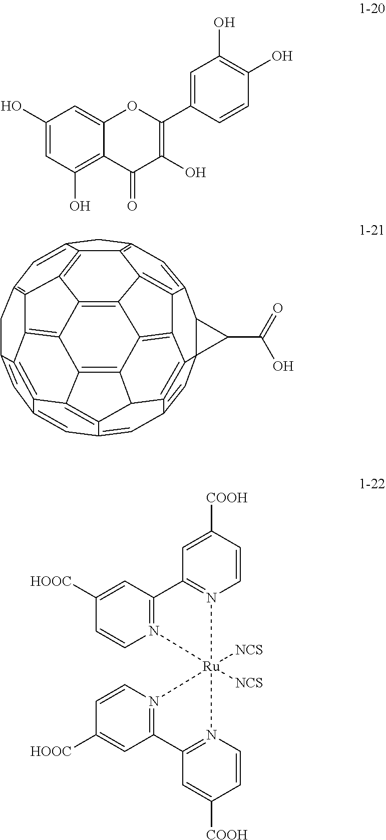

Examples of the method for attaching the electron-accepting compound onto the surfaces of the metal oxide particles include a dry method and a wet method.

The dry method is, for example, a method with which, while metal oxide particles are stirred with a mixer or the like having a large shear force, an electron-accepting compound as is or dissolved in an organic solvent is added dropwise or sprayed along with dry air or nitrogen gas so as to cause the electron-accepting compound to attach to the surfaces of the metal oxide particles. When the electron-accepting compound is added dropwise or sprayed, the temperature may be equal to or lower than the boiling point of the solvent. After the electron-accepting compound is added dropwise or sprayed, baking may be further conducted at 100° C. or higher. The temperature and time for baking are not particularly limited as long as the electrophotographic properties are obtained.

The wet method is, for example, a method with which, while metal oxide particles are dispersed in a solvent by stirring, ultrasonically, or by using a sand mill, an attritor, or a ball mill, the electron-accepting compound is added, followed by stirring or dispersing, and then the solvent is removed to cause the electron-accepting compound to attach to the surfaces of the metal oxide particles. The solvent is removed by, for example, filtration or distillation. After removing the solvent, baking may be further conducted at 100° C. or higher. The temperature and time for baking are not particularly limited as long as the electrophotographic properties are obtained. In the wet method, the moisture contained in the metal oxide particles may be removed before adding the electron-accepting compound. For example, the moisture may be removed by stirring and heating the metal oxide particles in a solvent or by boiling together with the solvent.

Attaching the electron-accepting compound may be conducted before, after, or simultaneously with the surface treatment of the metal oxide particles by a surface treatment agent.

The amount of the electron-accepting compound contained relative to the total solid content in the undercoat layer is, for example, 0.01 mass % or more and 20 mass % or less, may be 0.1 mass % or more and 10 mass % or less, or may be 0.5 mass % or more and 5 mass % or less.

When the amount of the electron-accepting compound contained is within the above-described range, the effects of the electron-accepting compound as the acceptor can be easily obtained compared to when the amount is below the range. Moreover, when the amount of the electron-accepting compound contained is within the above-described range, aggregation of the metal oxide particles and excessively uneven distribution of the metal oxide particles within the undercoat layer are less likely to occur compared to when the amount is beyond the range, and thus a rise in residual potential, occurrence of black dots, halftone density variation, and the like caused by excessively uneven distribution of the metal oxide particles are suppressed.

The amount of the electron-accepting compound contained relative to the total solid content in the undercoat layer may be 0.5 mass % or more and 2.0 mass % or less or may be 0.5 mass % or more and 1.0 mass % or less from the viewpoint of adjusting the electrostatic capacitance of the undercoat layer per unit area to be within the range described above.

### Additives in Undercoat Layer

The undercoat layer may further contain various additives.

For example, binder resin particles may be added as an additive. Examples of the binder resin particles include know materials such as silicone binder resin particles and crosslinking polymethyl methacrylate (PMMA) binder resin particles.

### Properties of Undercoat Layer

Other properties of the undercoat layer will now be described.

From the viewpoint of suppressing the multiple-color ghost, the thickness non-uniformity on the surface of the undercoat layer may be 0.4 μm or less, may be 0.3 μm or less, may be 0.2 μm or less, or may be 0.16 μm or less.

The thickness non-uniformity of the surface of the undercoat layer is measured by removing the layers (such as a photosensitive layer) on the outer circumferential surface of the conductive substrate in the electrophotographic photoreceptor with a cutter or the like or removing these layers by dissolving in a solvent or the like. Specifically, the thickness of the undercoat layer is measured with an eddy current thickness meter (produced by SIGMAKOKI Co., LTD.) at a total of five positions including the center of the conductive substrate and four points that are respectively ±1 cm away from the center in horizontal and vertical directions. Of the thickness values measured at the five points, the difference between the largest value and the smallest value is determined. This process is performed ten cycles, and the arithmetic mean value of the ten cycles is assumed to be the value of the thickness non-uniformity on the surface of the undercoat layer.

From the viewpoint of suppressing the rise in residual potential that occurs by repeating image formation, the thickness of the undercoat layer may be 3 μm or more and 50 μm or less, may be 3 μm or more and 30 μm or less, or may be 3 μm or more and 20 μm or less.

The thickness of the undercoat layer is measured with an eddy current thickness meter CTR-1500E produced by SANKO ELECTRONICS CORPORATION.

From the viewpoint of suppressing the rise in residual potential that occurs by repeating image formation, the volume resistivity of the undercoat layer may be 1.0×10⁴ (Ω·m) or more and 10×10¹⁰ (Ω·m) or less, may be 1.0×10⁶ (Ω·m) or more and 10×10⁸ (Ω·m) or less, or may be 1.0×10⁶ (Ω·m) or more and 10×10⁷ (Ω·m) or less.

An undercoat layer sample for volume resistivity measurement is prepared from the electrophotographic photoreceptor as follows. For example, coating films, such as a charge generating layer and a charge transporting layer, that cover the undercoat layer are removed with a solvent, such as acetone, tetrahydrofuran, methanol, or ethanol, and a gold electrode is attached to the exposed undercoat layer by a vacuum vapor deposition method, a sputtering method, or the like to prepare an undercoat layer sample for volume resistivity measurement.

When measuring the volume resistivity by an AC impedance method, SI 1287 electrochemical interface (produced by TOYO Corporation) is used as a power supply, SI 1260 impedance/gain phase analyzer (TOYO Corporation) is used as a current meter, and 1296 dielectric interface (produced by TOYO Corporation) is used as a current amplifier.

An AC voltage of 1 Vp-p is applied to the AC impedance measurement sample having an aluminum substrate serving as a cathode and a gold electrode serving as an anode over a frequency range of 1 MHz to 1 mHz from the high frequency side so as to measure the AC impedance of each sample, and a Cole-Cole plot graph obtained by the measurement is fitted with an RC parallel equivalent circuit to calculate the volume resistivity.

The undercoat layer may have a Vickers hardness of 35 or more.

In order to suppress moire images, the surface roughness (ten-point average roughness) of the undercoat layer may be adjusted to be in the range of 1/(4n) (n represents the refractive index of the overlying layer) to ½ of λ representing the laser wavelength used for exposure.

In order to adjust the surface roughness, binder resin particles and the like may be added to the undercoat layer. Examples of the binder resin particles include silicone binder resin particles and crosslinking polymethyl methacrylate binder resin particles. The surface of the undercoat layer may be polished to adjust the surface roughness. Examples of the polishing method included buff polishing, sand blasting, wet honing, and grinding.

The undercoat layer may be formed by any known method. For example, a coating film is formed by using an undercoat-layer-forming solution prepared by adding the above-mentioned components to a solvent, dried, and, if needed, heated.

Examples of the solvent used for preparing the undercoat-layer-forming solution include known organic solvents, such as alcohol solvents, aromatic hydrocarbon solvents, halogenated hydrocarbon solvents, ketone solvents, ketone alcohol solvents, ether solvents, and ester solvents.

Specific examples of the solvent include common organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

When the undercoat layer contains inorganic particles, examples of the method for dispersing the inorganic particles in preparing the undercoat-layer-forming solution include known methods that use a roll mill, a ball mill, a vibrating ball mill, an attritor, a sand mill, a colloid mill, and a paint shaker.

Examples of the method for applying the undercoat-layer-forming solution to the conductive substrate include common methods such as a blade coating method, a wire bar coating method, a spray coating method, a dip coating method, a bead coating method, an air knife coating method, and a curtain coating method.

### Intermediate Layer

Although not illustrated in the drawings, an intermediate layer may be further provided between the undercoat layer and the photosensitive layer.

The intermediate layer is, for example, a layer that contains a resin. Examples of the resin used in the intermediate layer include polymer compounds such as acetal resins (for example, polyvinyl butyral), polyvinyl alcohol resins, polyvinyl acetal resins, casein resins, polyamide resins, cellulose resins, gelatin, urethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may contain an organic metal compound. Examples of the organic metal compound used in the intermediate layer include organic metal compounds containing metal atoms such as zirconium, titanium, aluminum, manganese, and silicon.

These compound used in the intermediate layer may be used alone, or two or more compounds may be used as a mixture or a polycondensation product.

In particular, the intermediate layer may be a layer that contains an organic metal compound that contains zirconium atoms or silicon atoms.

The intermediate layer may be formed by any known method. For example, a coating film is formed by using an intermediate-layer-forming solution prepared by adding the above-mentioned components to a solvent, dried, and, if needed, heated.

Examples of the application method for forming the intermediate layer include common methods such as a dip coating method, a lift coating method, a wire bar coating method, a spray coating method, a blade coating method, a knife coating method, and a curtain coating method.

The thickness of the intermediate layer may be set within the range of, for example, 0.1 μm or more and 3 μm or less. The intermediate layer may be used as the undercoat layer.

### Photosensitive Layer

### Charge Generating Layer

The charge generating layer is, for example, a layer that contains a charge generating material and a binder resin. The charge generating layer may be a vapor deposited layer of a charge generating material. The vapor deposited layer of the charge generating material may be used when an incoherent light such as a light emitting diode (LED) or an organic electro-luminescence (EL) image array is used.

Examples of the charge generating material include azo pigments such as bisazo and trisazo pigments; fused-ring aromatic pigments such as dibromoanthanthrone; perylene pigments; pyrrolopyrrole pigments; phthalocyanine pigments; zinc oxide; and trigonal selenium.

Among these, in order to be compatible to the near-infrared laser exposure, preferably, a metal phthalocyanine pigment or a metal-free phthalocyanine pigment is used as the charge generating material. Specific examples thereof include hydroxygallium phthalocyanine, chlorogallium phthalocyanine, dichlorotin phthalocyanine, and titanyl phthalocyanine.

In order to be compatible to the near ultraviolet laser exposure, the charge generating material is preferably a fused-ring aromatic pigment such as dibromoanthanthrone, a thioindigo pigment, a porphyrazine compound, zinc oxide, trigonal selenium, or a bisazo pigment.

When an incoherent light source, such as an LED or an organic EL image array having an emission center wavelength in the range of 450 nm or more and 780 nm or less, is used, the charge generating material described above may be used; however, from the viewpoint of the resolution, when the photosensitive layer is as thin as 20 μm or less, the electric field intensity in the photosensitive layer is increased, charges injected from the substrate are decreased, and image defects known as black spots tend to occur. This is particularly noticeable when a charge generating material, such as trigonal selenium or a phthalocyanine pigment, that is of a p-conductivity type and easily generates dark current is used.

In contrast, when an n-type semiconductor, such as a fused-ring aromatic pigment, a perylene pigment, or an azo pigment, is used as the charge generating material, dark current rarely occurs and, even when the thickness is small, image defects known as black spots can be suppressed.

The binder resin used in the charge generating layer is selected from a wide range of insulating resins. Alternatively, the binder resin may be selected from organic photoconductive polymers, such as poly-N-vinylcarbazole, polyvinyl anthracene, polyvinyl pyrene, and polysilane.

Examples of the binder resin include, polyvinyl butyral resins, polyarylate resins (polycondensates of bisphenols and aromatic dicarboxylic acids etc.), polycarbonate resins, polyester resins, phenoxy resins, vinyl chloride-vinyl acetate copolymers, acrylic resins, polyvinyl pyridine resins, cellulose resins, urethane resins, epoxy resins, casein, polyvinyl alcohol resins, and polyvinyl pyrrolidone resins. Here, “insulating” means having a volume resistivity of 10¹³ Ωcm or more.

These binder resins are used alone or in combination as a mixture.

The blend ratio of the charge generating material to the binder resin may be in the range of 10:1 to 1:10 on a mass ratio basis.

The charge generating layer may contain other known additives.

The charge generating layer may be formed by any known method. For example, a coating film is formed by using an charge-generating-layer-forming solution prepared by adding the above-mentioned components to a solvent, dried, and, if needed, heated. The charge generating layer may be formed by vapor-depositing a charge generating material. The charge generating layer may be formed by vapor deposition particularly when a fused-ring aromatic pigment or a perylene pigment is used as the charge generating material.

Specific examples of the solvent for preparing the charge-generating-layer-forming solution include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in combination as a mixture.

The method for dispersing particles (for example, the charge generating material) in the charge-generating-layer-forming solution can use a media disperser such as a ball mill, a vibrating ball mill, an attritor, a sand mill, or a horizontal sand mill, or a media-less disperser such as stirrer, an ultrasonic disperser, a roll mill, or a high-pressure homogenizer. Examples of the high-pressure homogenizer include a collision-type homogenizer in which the dispersion in a high-pressure state is dispersed through liquid-liquid collision or liquid-wall collision, and a penetration-type homogenizer in which the fluid in a high-pressure state is caused to penetrate through fine channels.

In dispersing, it is effective to set the average particle diameter of the charge generating material in the charge-generating-layer-forming solution to 0.5 μm or less, 0.3 μm or less, or 0.15 μm or less.

Examples of the method for applying the charge-generating-layer-forming solution to the undercoat layer (or the intermediate layer) include common methods such as a blade coating method, a wire bar coating method, a spray coating method, a dip coating method, a bead coating method, an air knife coating method, and a curtain coating method.

The thickness of the charge generating layer may be set within the range of, for example, 0.1 μm or more and 5.0 μm or less, or with in the range of 0.2 μm or more and 2.0 μm or less.

### Charge Transporting Layer

The charge transporting layer is a layer that contains a charge transporting material and a binder resin, for example. The charge transporting layer may be a layer that contains a polymer charge transporting material.

Examples of the charge transporting material include electron transporting compounds such as quinone compounds such as p-benzoquinone, chloranil, bromanil, and anthraquinone; tetracyanoquinodimethane compounds; fluorenone compounds such as 2,4,7-trinitrofluorenone; xanthone compounds; benzophenone compounds; cyanovinyl compounds; and ethylene compounds. Other examples of the charge transporting material include hole transporting compounds such as triarylamine compounds, benzidine compounds, aryl alkane compounds, aryl-substituted ethylene compounds, stilbene compounds, anthracene compounds, and hydrazone compounds. These charge transporting materials may be used alone or in combination, but are not limiting.

From the viewpoint of charge mobility, the charge transporting material may be a triaryl amine derivative represented by structural formula (a-1) below or a benzidine derivative represented by structural formula (a-2) below.

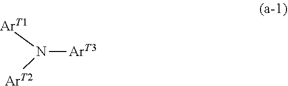

In structural formula (a-1), Ar^{T1}, Ar^{T2}, and Ar^{T3} each independently represent a substituted or unsubstituted aryl group, —C₆H₄—C(R^{T4})═C(R^{T5}) (R^{T6}) or —C₆H₄−CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent for each of the groups described above include a halogen atom, an alkyl group having 1 to 5 carbon atoms, and an alkoxy group having 1 to 5 carbon atoms. Examples of the substituent for each of the groups described above include a substituted amino group substituted with an alkyl group having 1 to 3 carbon atoms.

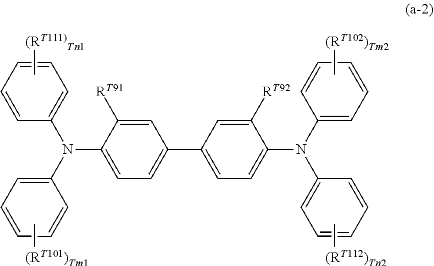

In structural formula (a-2), R^{T91} and R^{T92} each independently represent a hydrogen atom, a halogen atom, an alkyl group having 1 to 5 carbon atoms, or an alkoxy group having 1 to 5 carbon atoms. R^{T101}, R^{T102}, R^{T111}, and R^{T112} each independently represent a halogen atom, an alkyl group having 1 to 5 carbon atoms, an alkoxy group having 1 to 5 carbon atoms, an amino group substituted with an alkyl group having 1 or 2 carbon atoms, a substituted or unsubstituted aryl group, −C(R^{T12})═R(R^{T13})(R^{T14}), or —CH═CH—CH═C(R^{T15})(R^{T16}); and R^{T12}, R^{T13}, RT¹⁴, RT¹⁵ and R^{T16} each independently represent a hydrogen atom, a substituted or unsubstituted alkyl group, or a substituted or unsubstituted aryl group. Tm1, Tm2, Tn1, and Tn2 each independently represent an integer of 0 or more and 2 or less.

Examples of the substituent for each of the groups described above include a halogen atom, an alkyl group having 1 to 5 carbon atoms, and an alkoxy group having 1 to 5 carbon atoms. Examples of the substituent for each of the groups described above include a substituted amino group substituted with an alkyl group having 1 to 3 carbon atoms.

Among the triarylamine derivatives represented by structural formula (a-1) and the benzidine derivatives represented by structural formula (a-2) above, a triarylamine derivative having —C₆H₄—CH═CH—CH═C(R^{T7})(R^{T8}) or a benzidine derivative having —CH═CH—CH═C(R^{T15}) (R^{T16}) may be used from the viewpoint of the charge mobility.

Examples of the polymer charge transporting material that can be used include known charge transporting materials such as poly-N-vinylcarbazole and polysilane. In particular, polyester polymer charge transporting materials may be used. The polymer charge transporting material may be used alone or in combination with a binder resin.

Examples of the binder resin used in the charge transporting layer include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly-N-vinylcarbazole, and polysilane. Among these, a polycarbonate resin or a polyarylate resin may be used as the binder resin. These binder resins are used alone or in combination.

The blend ratio of the charge transporting material to the binder resin may be in the range of 10:1 to 1:5 on a mass ratio basis.

The charge transporting layer may contain other known additives.

The charge transporting layer may be formed by any known method. For example, a coating film is formed by using an charge-transporting-layer-forming solution prepared by adding the above-mentioned components to a solvent, dried, and, if needed, heated.

Examples of the solvent used to prepare the charge-transporting-layer-forming solution include common organic solvents such as aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in combination as a mixture.

Examples of the method for applying the charge-transporting-layer-forming solution to the charge generating layer include common methods such as a blade coating method, a wire bar coating method, a spray coating method, a dip coating method, a bead coating method, an air knife coating method, and a curtain coating method.

The thickness of the charge transporting layer may be set within the range of, for example, 5 μm or more and 50 μm or less, or within the range of 10 μm or more and 30 μm or less.

### Protective Layer

A protective layer is disposed on a photosensitive layer if necessary. The protective layer is, for example, formed to avoid chemical changes in the photosensitive layer during charging and further improve the mechanical strength of the photosensitive layer.

Thus, the protective layer may be a layer formed of a cured film (crosslinked film). Examples of such a layer include layers indicated in 1) and 2) below.

1) A layer formed of a cured film of a composition that contains a reactive-group-containing charge transporting material having a reactive group and a charge transporting skeleton in the same molecule (in other words, a layer that contains a polymer or crosslinked body of the reactive-group-containing charge transporting material).

2) A layer formed of a cured film of a composition that contains a non-reactive charge transporting material, and a reactive-group-containing non-charge transporting material that does not have a charge transporting skeleton but has a reactive group (in other words, a layer that contains a polymer or crosslinked body of the non-reactive charge transporting material and the reactive-group-containing non-charge transporting material).

Examples of the reactive group contained in the reactive-group-containing charge transporting material include chain-polymerizable groups, an epoxy group, —OH, —OR (where R represents an alkyl group), —NH₂, —SH, —COOH, or —SiR^{Q1}_{3-Qn}(OR^{Q2})_{Qn} (where RQ1 represents a hydrogen atom, an alkyl group, or a substituted or unsubstituted aryl group, RQ2 represents a hydrogen atom, an alkyl group, or a trialkylsilyl group, and Qn represents an integer of 1 to 3).

The chain-polymerizable group may be any radical-polymerizable functional group, and an example thereof is a functional group having a group that contains at least a carbon-carbon double bond. A specific example thereof is a group that contains at least one selected from a vinyl group, a vinyl ether group, a vinyl thioether group, a vinylphenyl group, an acryloyl group, a methacryloyl group, and derivatives thereof. Among these, the chain-polymerizable group may be a group that contains at least one selected from a vinyl group, a vinylphenyl group, an acryloyl group, a methacryloyl group, and derivatives thereof due to their excellent reactivity.

The charge transporting skeleton of the reactive-group-containing charge transporting material may be any known structure used in the electrophotographic photoreceptor, and examples thereof include skeletons that are derived from nitrogen-containing hole transporting compounds, such as triarylamine compounds, benzidine compounds, and hydrazone compounds, and that are conjugated with nitrogen atoms. Among these, a triarylamine skeleton may be used.

The reactive-group-containing charge transporting material that has such a reactive group and a charge transporting skeleton, the non-reactive charge transporting material, and the reactive-group-containing non-charge transporting material may be selected from among known materials.

The protective layer may contain other known additives.

The protective layer may be formed by any known method. For example, a coating film is formed by using a protective-layer-forming solution prepared by adding the above-mentioned components to a solvent, dried, and, if needed, cured such as by heating.

Examples of the solvent used to prepare the protective-layer-forming solution include aromatic solvents such as toluene and xylene, ketone solvents such as methyl ethyl ketone, methyl isobutyl ketone, and cyclohexanone, ester solvents such as ethyl acetate and butyl acetate, ether solvents such as tetrahydrofuran and dioxane, cellosolve solvents such as ethylene glycol monomethyl ether, and alcohol solvents such as isopropyl alcohol and butanol. These solvents are used alone or in combination as a mixture.

The protective-layer-forming solution may be a solvent-free solution.

Examples of the application method used to apply the protective-layer-forming solution onto the photosensitive layer (for example, the charge transporting layer) include common methods such as a dip coating method, a lift coating method, a wire bar coating method, a spray coating method, a blade coating method, a knife coating method, and a curtain coating method.

The thickness of the protective layer may be set within the range of, for example, 1 μm or more and 20 μm or less, or within the range of 2 μm or more and 10 μm or less.

### Single-Layer-Type Photosensitive Layer

The single-layer-type photosensitive layer (charge generating/charge transporting layer) is, for example, a layer that contains a charge generating material, a charge transporting material, and, optionally, a binder resin and other known additives. These materials are the same as those described in relation to the charge generating layer and the charge transporting layer.

The amount of the charge generating material contained in the single-layer-type photosensitive layer relative to the total solid content may be 0.1 mass % or more and 10 mass % or less, or may be 0.8 mass % or more and 5 mass % or less. The amount of the charge transporting material contained in the single-layer-type photosensitive layer relative to the total solid content may be 5 mass % or more and 50 mass % or less.

The method for forming the single-layer-type photosensitive layer is the same as the method for forming the charge generating layer and the charge transporting layer.

The thickness of the single-layer-type photosensitive layer may be, for example, 5 μm or more and 50 μm or less, or 10 μm or more and 40 μm or less.

### Image Forming Apparatus and Process Cartridge

An image forming apparatus according to the exemplary embodiment includes at least two image forming units arranged side-by-side in a direction in which a transfer-receiving member travels, each of the image forming units including: an electrophotographic photoreceptor that includes a conductive substrate having a surface, an undercoat layer disposed on the surface of the conductive substrate, and a photosensitive layer on the undercoat layer, in which a maximum height waviness of a waviness profile of the surface of the conductive substrate on which the undercoat layer is disposed is 1.4 μm or less, and the undercoat layer contains a binder resin and has a thickness non-uniformity of 0.4 μm or less; a charging unit that charges a surface of the electrophotographic photoreceptor by a charging method involving applying a DC voltage; an electrostatic latent image forming unit that forms an electrostatic latent image on the charged surface of the electrophotographic photoreceptor; and a developing unit that develops the electrostatic latent image on the surface of the electrophotographic photoreceptor by using a developer containing a toner so as to form a toner image. However, the image forming units do not include a charge erasing unit that erases charges on the surface of the electrophotographic photoreceptor. The image forming apparatus further includes a transfer unit that transfers the toner image onto a surface of a transfer-receiving member.

The image forming apparatus of the exemplary embodiment is applied to a known image forming apparatus, examples of which include an apparatus equipped with a fixing unit that fixes the toner image transferred onto the surface of the recording medium; a direct transfer type apparatus with which the toner image formed on the surface of the electrophotographic photoreceptor is directly transferred to the recording medium; an intermediate transfer type apparatus with which the toner image formed on the surface of the electrophotographic photoreceptor is first transferred to a surface of an intermediate transfer body and then the toner image on the surface of the intermediate transfer body is transferred to the surface of the recording medium; an apparatus equipped with a cleaning unit that cleans the surface of the electrophotographic photoreceptor after the toner image transfer and before charging; and an apparatus equipped with an electrophotographic photoreceptor heating member that elevates the temperature of the electrophotographic photoreceptor to reduce the relative temperature.

In the intermediate transfer type apparatus, the transfer unit includes, for example, an intermediate transfer body having a surface onto which a toner image is to be transferred, a first transfer unit that conducts first transfer of the toner image on the surface of the electrophotographic photoreceptor onto the surface of the intermediate transfer body, and a second transfer unit that conducts second transfer of the toner image on the surface of the intermediate transfer body onto a surface of a recording medium.

When the image forming apparatus of the exemplary embodiment is of an intermediate transfer type, the transfer-receiving member corresponds to the intermediate transfer body. When the image forming apparatus of the exemplary embodiment is of a direct transfer type, the transfer-receiving member corresponds to the recording medium.

The image forming apparatus of this exemplary embodiment may be of a dry development type or a wet development type (development type that uses a liquid developer).

In the image forming apparatus of this exemplary embodiment, the “image forming unit” is, as mentioned above, an image forming unit equipped with an electrophotographic photoreceptor, a charging unit, an electrostatic latent image forming unit, and a developing unit. The image forming unit may be further equipped with a cleaning unit that cleans the surface of the electrophotographic photoreceptor after the toner image transfer and before charging.

In the image forming apparatus of the exemplary embodiment, for example, a section that includes the electrophotographic photoreceptor in each image forming unit may be configured as a cartridge structure (process cartridge) detachably attachable to the image forming apparatus. That is, a process cartridge of the exemplary embodiment detachable from and attachable to an image forming apparatus includes an electrophotographic photoreceptor that includes a conductive substrate having a surface, an undercoat layer disposed on the surface of the conductive substrate, and a photosensitive layer on the undercoat layer, in which a maximum height waviness of a waviness profile of the surface of the conductive substrate on which the undercoat layer is disposed is 1.4 μm or less, and the undercoat layer contains a binder resin and has a thickness non-uniformity of 0.4 μm or less. However, the process cartridge does not include a charge erasing unit that erases charges on a surface of the electrophotographic photoreceptor.

Although, some examples of the image forming apparatus of an exemplary embodiment are described below, these examples are not limiting. The relevant sections illustrated in the drawings are described, and descriptions of other sections are omitted.

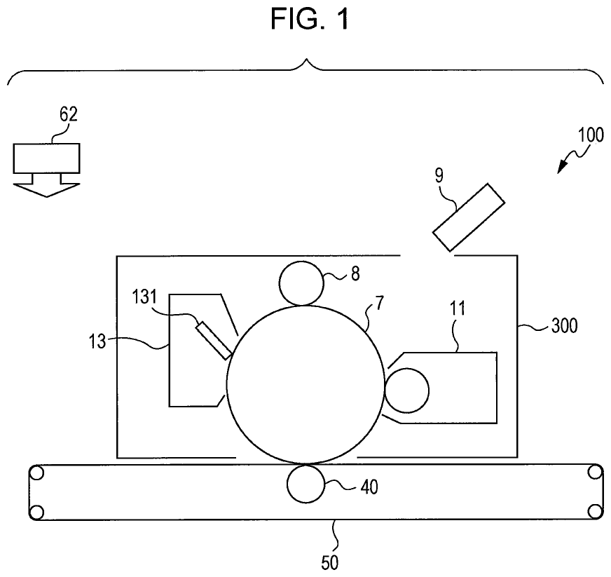

FIG. 1 is a schematic diagram illustrating one example of an image forming apparatus according to the exemplary embodiment. FIG. 1 schematically illustrates one of multiple image forming units of a tandem-system multiple-color image forming apparatus. As illustrated in FIG. 1, an image forming apparatus 100 of this exemplary embodiment includes an image forming unit 300 that includes an electrophotographic photoreceptor 7, and, around the electrophotographic photoreceptor 7, a charging device 8 (one example of the charging unit), an exposing unit device 9 (one example of the electrostatic latent image forming unit), and a developing device 11 (one example of the developing unit). The image forming apparatus 100 further includes a transfer device 40 (first transfer device), and an intermediate transfer body 50. The image forming apparatus 100 also includes a control device 62 that is connected to the devices and members in the image forming apparatus 100 to control the operation of the devices and members. The image forming apparatus 100 illustrated in FIG. 1 is an eraseless-type image forming apparatus that does not include a charge erasing device (one example of the charge erasing unit) that erases the charges remaining on the surface of the electrophotographic photoreceptor 7 after the transfer device 40 transfers the toner image on the surface of the electrophotographic photoreceptor 7 onto the intermediate transfer body 50 and before the charging device 8 charges the surface of the electrophotographic photoreceptor 7. Moreover, the charging device 8 is of a type that applies direct current.

In this image forming apparatus 100, the exposing device 9 is positioned so that light can be applied to the electrophotographic photoreceptor 7 from the opening in the image forming unit 300, the transfer device 40 is positioned to oppose the electrophotographic photoreceptor 7 with the intermediate transfer body 50 therebetween, and the intermediate transfer body 50 has a portion in contact with the electrophotographic photoreceptor 7. Although not shown in the drawings, a second transfer device that transfers the toner image on the intermediate transfer body 50 onto a recording medium (for example, a paper sheet) is also provided. The intermediate transfer body 50, the transfer device 40 (first transfer device), and the second transfer device (not illustrated) correspond to examples of the transfer unit. The image forming unit 300 may be a process cartridge.

The image forming unit 300 illustrated in FIG. 1 integrates and supports the electrophotographic photoreceptor 7, the charging device 8 (one example of the charging unit), the developing device 11 (one example of the developing unit), and the cleaning device 13 (one example of the cleaning unit) in the housing. The cleaning device 13 has a cleaning blade (one example of the cleaning member) 131, and the cleaning blade 131 is in contact with the surface of the electrophotographic photoreceptor 7. The cleaning member may take a form other than the cleaning blade 131, and may be a conductive or insulating fibrous member that can be used alone or in combination with the cleaning blade 131.

The image forming apparatus illustrated in FIG. 1 may optionally be further equipped with a fibrous member (roll) that supplies a lubricant to the surface of the electrophotographic photoreceptor 7 and a fibrous member (flat brush) that assists cleaning.

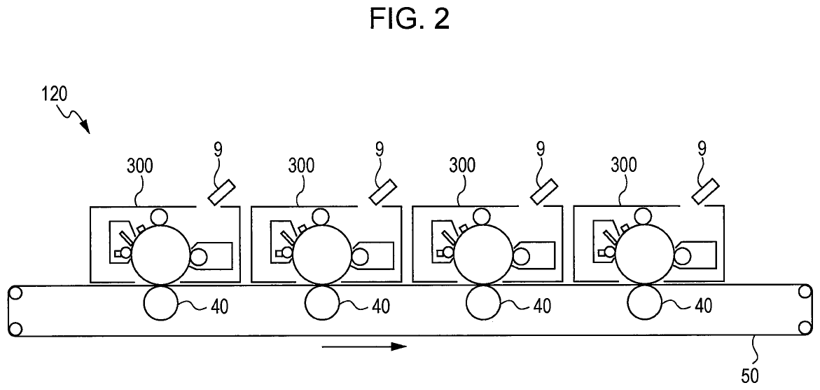

FIG. 2 is a schematic diagram illustrating another example of the image forming apparatus according to this exemplary embodiment.

FIG. 2 schematically illustrates an example of a tandem-system multi-color image forming apparatus 120 equipped with four image forming units 300. In the image forming apparatus 120, four image forming units 300 are arranged side-by-side on the intermediate transfer body 50 serving as the transfer-receiving member, and one electrophotographic photoreceptor is used for one color. The image forming units 300 of the image forming apparatus 120 are each identical to the image forming apparatus 100.

The features of the image forming apparatus of this exemplary embodiment will now be described.

### Charging Device

Examples of the charging device 8 include contact-type chargers that use conductive or semi-conducting charging rollers, charging brushes, charging films, charging rubber blades, and charging tubes. Known chargers such as non-contact-type roller chargers, and scorotron chargers and corotron chargers that utilize corona discharge are also be used.

The charging device 8 is, for example, electrically connected to the control device 62 in the image forming apparatus 100, and is driven and controlled by the control device 62 so that a DC voltage is applied to the charging device 8. The charging device 8 charges the electrophotographic photoreceptor 7 to a charge potential corresponding to the applied charge voltage.

### Exposing Device

Examples of the exposing device 9 include optical devices that can apply light, such as semiconductor laser light, LED light, or liquid crystal shutter light, into a particular image shape onto the surface of the electrophotographic photoreceptor 7. The wavelength of the light source is to be within the spectral sensitivity range of the electrophotographic photoreceptor. The mainstream wavelength of the semiconductor lasers is near infrared having an oscillation wavelength at about 780 nm. However, the wavelength is not limited to this, and a laser having an oscillation wavelength on the order of 600 nm or a blue laser having an oscillation wavelength of 400 nm or more and 450 nm or less may be used. In order to form a color image, a surface-emitting laser light source that can output multi beams is also effective.

### Developing Device

Examples of the developing device 11 include common developing devices that perform development by using a developer in contact or non-contact manner. The developing device 11 is not particularly limited as long as the aforementioned functions are exhibited, and is selected according to the purpose. An example thereof is a known developing device that has a function of attaching a one-component developer or a two-component developer to the electrophotographic photoreceptor 7 by using a brush, a roller, or the like. In particular, a development roller that retains the developer on its surface may be used.

The developer used in the developing device 11 may be a one-component developer that contains only a toner or a two-component developer that contains a toner and a carrier. The developer may be magnetic or non-magnetic. Any known developers may be used as these developers.

### Cleaning Device

A cleaning blade type device equipped with a cleaning blade 131 is used as the cleaning device 13.

Instead of the cleaning blade type, a fur brush cleaning type device or a development-cleaning simultaneous type device may be employed.

### Transfer Device

Examples of the transfer device 40 include contact-type transfer chargers that use belts, rollers, films, rubber blades, etc., and known transfer chargers such as scorotron transfer chargers and corotron transfer chargers that utilize corona discharge.

### Intermediate Transfer Body

A belt-shaped member (intermediate transfer belt) that contains semi-conducting polyimide, polyamide imide, polycarbonate, polyarylate, a polyester, a rubber or the like is used as the intermediate transfer body 50. The form of the intermediate transfer body other than the belt may be a drum.

Control Device

The control device 62 is configured as a computer that performs control and various computing for the entire image forming apparatus. Specifically, the control device 62 is equipped with a central processing unit (CPU), a read only memory (ROM) storing various programs, a random access memory (RAM) used as the work area during execution of the program, a non-volatile memory storing various information, and an input/output interface (I/O). The CPU, the ROM, the RAM, the non-volatile memory, and the I/O are connected through a bus. Various devices of the image forming apparatus 100, such as the electrophotographic photoreceptor 7, the charging device 8, the exposing device 9, the developing device 11, the transfer device 40, the cleaning device 13, etc., are connected to the I/O.

The CPU, for example, runs the program stored in the ROM or the non-volatile memory (for example, a control program such as an image forming sequence or recovering sequence), and controls the operation of the respective devices of the image forming apparatus 100. The RAM is used as a work memory. Programs executed by the CPU and data necessary for processing in the CPU are stored in the ROM and the non-volatile memory. The control programs and various data may be stored in other storing devices, such as a storage unit, or may be acquired from exterior through a communication unit.

Various types of drives may be connected to the control device 62. Examples of the drives include devices that can read data from a computer-readable portable recording medium P, such as a flexible disk, a magnetooptical disk, a CD-ROM, a DVD-ROM, or a universal serial bus (USB) memory, and devices that can write data on the recording media P. When a drive is provided, a control program may be stored in a portable recording medium P and the program may be executed by reading the portable recording medium with a corresponding drive.

### Image Forming Operation

Next, referring to FIG. 2, the image forming operation of the image forming apparatus 120 illustrated in FIG. 2 is described. First, a toner image is formed in the image forming unit 300 on the upstream side in the intermediate transfer body 50 traveling direction, and transferred onto the intermediate transfer body 50. Next, a toner image is formed in the image forming unit 300 on the downstream side in the intermediate transfer body 50 traveling direction, and transferred onto the intermediate transfer body 50. Here, the toner image formed by the image forming unit 300 on the downstream side in the intermediate transfer body 50 travelling direction is superimposed onto the toner image formed by the image forming unit 300 on the upstream side in the intermediate transfer body 50 travelling direction, and thus a toner image containing multiple-color toner images is formed. The toner image transferred onto the intermediate transfer body 50 is then fixed to a surface of a recording medium by a second fixing device not illustrated in the drawing.

A toner image is formed as follows. First, the surface of the electrophotographic photoreceptor 7 is charged by the charging device 8. Next, the exposure device 9 applies light, based on the image information, to the charged surface of the electrophotographic photoreceptor 7. As a result, an electrostatic latent image corresponding to the image information is formed on the electrophotographic photoreceptor 7. In the developing device 11, the electrostatic latent image formed on the surface of the electrophotographic photoreceptor 7 is developed by using a developer containing a toner. As a result, a toner image is formed on the surface of the electrophotographic photoreceptor 7. In the developing device 40, the toner image on the surface of the electrophotographic photoreceptor 7 is transferred onto the intermediate transfer body 50. The surface of the electrophotographic photoreceptor 7 after the toner image transfer is cleaned with the cleaning device 13, and the next cycle of image formation operation is performed without a step of removing charges remaining on the surface of the electrophotographic photoreceptor 7.

### EXAMPLES

The present disclosure will now be described in further detail through Examples which do not limit the scope of the present disclosure. Unless otherwise noted, “parts” means “parts by mass”.

### Example 1

### Preparation of Undercoat Layer

One hundred parts by mass of zinc oxide (volume-average primary particle diameter: 70 nm, produced by Tayca Corporation, BET specific surface area: 15 m²/g) serving as metal oxide particles and 500 parts by mass of methanol are mixed by stirring, 1.25 parts by mass of KBM603 (produced by Shin-Etsu Chemical Co., Ltd.) serving as a silane coupling agent is added thereto, and the resulting mixture is stirred for 2 hours. Then, methanol is distilled away by vacuum distillation, baking is performed at 120° C. for 3 hours, and, as a result, zinc oxide particles surface-treated with a silane coupling agent are obtained.

A mixture is prepared by mixing 44.6 parts by mass of the zinc oxide particles surface-treated with a silane coupling agent, 0.45 parts by mass of hydroxyanthraquinone “Example Compound (1-1)” serving as an electron-accepting compound, 10.2 parts by mass of blocked isocyanate (Sumidur 3173 produced by Sumitomo Bayer Urethane Co., Ltd.) serving as a curing agent, 3.5 parts by mass of a butyral resin (trade name: S-LEC BM-1 produced by Sekisui Chemical Co., Ltd.), 0.005 parts by mass of dioctyltin dilaurate serving as a catalyst, and 41.3 parts by mass of methyl ethyl ketone, and is then dispersed in a sand mill with glass beads having a diameter of 1 mm for 4 hours (dispersing time: 4 hours), and a dispersion is obtained as a result. To the dispersion, 3.6 parts by mass of silicone resin particles (Tospearl 145 produced by Momentive Performance Materials Inc.) are added to obtain an undercoat-layer-forming solution. The viscosity of the undercoat-layer-forming solution at a coating temperature of 24° C. is 235 mPa·s.

The undercoat-layer-forming solution is applied to a conductive substrate (aluminum substrate, diameter: 30 mm, length: 357 mm, thickness: 1.0 mm) having a surface texture indicated in Table by a dip coating method at a coating speed of 220 mm/min, and the applied solution is dried and cured at 190° C. for 24 minutes to obtain an undercoat layer having a thickness of 19 μm. The surface of the conductive substrate is cut so that the conductive substrate has the surface texture indicated in Table.

### Preparation of Charge Generating Layer

A mixture containing 15 parts by mass of hydroxygallium phthalocyanine serving as a charge generating material and having diffraction peaks at least at Bragg's angles (2θ±0.2° of 7.3°, 16.0°, 24.9°, and 28.0° in an X-ray diffraction spectrum obtained by using CuKα X-ray, 10 parts by mass of a vinyl chloride-vinyl acetate copolymer binder resin (VMCH produced by Nippon Unicar Company Limited) serving as a binder resin, and 200 parts by mass of n-butyl acetate is stirred and dispersed in a sand mill with glass beads having a diameter ϕ of 1 mm for 4 hours. To the resulting dispersion, 175 parts by mass of n-butyl acetate and 180 parts by mass of methyl ethyl ketone are added and stirred so as to obtain a charge-generating-layer-forming solution. This charge-generating-layer-forming solution is applied to the undercoat layer by dip coating. Subsequently, the applied solution is dried at 140° C. for 10 minutes to form a charge generating layer having a thickness of 0.2

### Preparation of Charge Transporting Layer

To 800 parts by mass of tetrahydrofuran, 40 parts by mass of a charge transporting agent (HT-1), 8 parts by mass of a charge transporting agent (HT-2), and 52 parts by mass of a polycarbonate binder resin (A) (viscosity-average molecular weight: 50,000) are added and dissolved, 8 parts by mass of tetraethylene fluoride binder resin (Lubron L5 produced by Daikin Industries Ltd., average particle diameter: 300 nm) is added, and the resulting mixture is dispersed for 2 hours by using a homogenizer (ULTRA-TURRAX T50 produced by IKA Japan) at 5500 rpm to obtain a charge-transporting-layer-forming solution.

The solution is applied to the charge generating layer. Subsequently, the applied solution is dried at 140° C. for 40 minutes to form a charge transporting layer having a thickness of 27 μm. The resulting product is used as the electrophotographic photoreceptor.

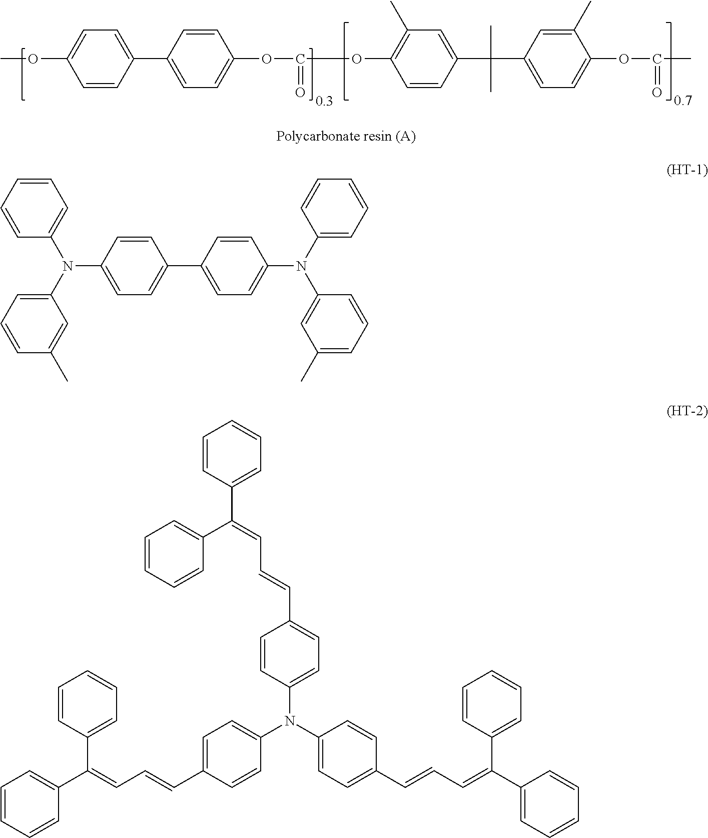

### Comparative Examples 1 and 2

Electrophotographic photoreceptors are obtained by the same process as in Example 1 except that the maximum height waviness and the mean width of the waviness profile of the surface of the conductive substrate and the thickness non-uniformity on the surface of the undercoat layer are changed to those indicated in Table.

### Examples 2 to 11

Electrophotographic photoreceptors are obtained by the same process as in Example 1 except that the maximum height waviness and the mean width of the waviness profile of the surface of the conductive substrate, the thickness non-uniformity on the surface of the undercoat layer, the type of the resin, and the type and content of the metal oxide particles are changed to those indicated in Table.

### Example 12

An electrophotographic photoreceptor is obtained by the same process as in Example 1 except that the material and amount of the binder resin are changed to a “phenolic resin (WR-103 produced by DIC Corporation)” and 40 parts by mass and the solvent is changed to “cyclohexanone (FUJIFILM Wako Pure Chemical Corporation)” and 60 parts by mass in the step of preparing the undercoat layer.

### Evaluation of Multiple-Color Ghost

After a tertiary color halftone image having an image density of 50% RH is formed in an environment having a temperature of 22° C. and a humidity of 50% RH, a multiple-color ghost that appears in a blank image and a halftone image of the next cycle is observed with naked eye, and evaluation is conducted according to the evaluation standard below (Table). A and B are acceptable.

### Evaluation Standard

A: No multiple-color ghost is observed with naked eye.

B: Multiple-color ghost is observed with naked eye but the extent is acceptable.

C: Multiple-color ghost is observed with naked eye, and the extent is unacceptable.

TABLE

| | Surface of | | | | | | |
|---|---|---|---|---|---|---|---|
| | conductive substrate | | Undercoat layer | | | Amount of metal | |
| | Maximum height | Mean width of | Thickness | | | oxide particles | |
| | waviness of | waviness | non- | | | relative to total solid | Evaluation |
| | waviness profile | profile | uniformity | Type of metal | | content of undercoat | of multiple- |
| | [μm] | [mm] | [μm] | oxide particles | Type or resin | layer [mass %] | color ghost |
| Example 1 | 1.2 | 0.87 | 0.15 | Zinc oxide | Urethane resin | 75% | A |
| Example 2 | 1.2 | 0.15 | 0.39 | Zinc oxide | Urethane resin | 75% | B |
| Example 3 | 1.2 | 30 | 0.14 | Zinc oxide | Urethane resin | 75% | B |
| Example 4 | 1.0 | 0.87 | 0.13 | Zinc oxide | Urethane resin | 75% | A |
| Example 5 | 0.8 | 0.87 | 0.12 | Zinc oxide | Urethane resin | 75% | A |
| Example 6 | 1.2 | 0.87 | 0.15 | Titanium oxide | Urethane resin | 75% | B |
| Example 7 | 1.2 | 0.87 | 0.15 | Tin oxide | Urethane resin | 75% | B |
| Example 8 | 1.2 | 0.87 | 0.15 | Iron oxide | Urethane resin | 75% | B |
| Example 9 | 1.2 | 0.87 | 0.15 | — | Urethane resin | — | B |
| Example 10 | 1.2 | 0.87 | 0.15 | Zinc oxide | Urethane resin | 5 | B |
| Example 11 | 1.2 | 0.87 | 0.15 | Zinc oxide | Urethane resin | 90 | B |
| Example 12 | 1.2 | 0.87 | 0.15 | Zinc oxide | Urethane resin | 75% | B |
| Comparative | 1.2 | 0.28 | 0.62 | Zinc oxide | Phenolic resin | 75% | C |
| Example 1 | | | | | | | |
| Comparative | 1.7 | 0.98 | 0.49 | Zinc oxide | Urethane resin | 75% | C |
| Example 2 | | | | | | | |

The results indicated above indicate that occurrence of the multiple-color ghost is suppressed more in the electrophotographic photoreceptors of Examples 1 to 12 than in the electrophotographic photoreceptors of Comparative Examples 1 and 2.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An electrophotographic photoreceptor comprising:
a conductive substrate having a surface;
an undercoat layer disposed on the surface of the conductive substrate; and
a photosensitive layer on the undercoat layer,
wherein a maximum height waviness of a waviness profile of the surface of the conductive substrate on which the undercoat layer is disposed is 1.4 μm or less, and
the undercoat layer contains a binder resin and has a thickness non-uniformity of 0.4 μm or less.

2. The electrophotographic photoreceptor according to claim 1, wherein a mean width of the waviness profile of the surface of the conductive substrate on which the undercoat layer is disposed is 0.5 mm or more.

3. The electrophotographic photoreceptor according to claim 1, wherein a mean width of the waviness profile of the surface of the conductive substrate on which the undercoat layer is disposed is 0.6 mm or more.

4. The electrophotographic photoreceptor according to claim 2, wherein the mean width of the waviness profile of the surface of the conductive substrate on which the undercoat layer is disposed is 20 mm or less.

5. The electrophotographic photoreceptor according to claim 1, wherein the undercoat layer includes metal oxide particles.

6. The electrophotographic photoreceptor according to claim 5, wherein the metal oxide particles are at least one type of metal oxide particles selected from the group consisting of zinc oxide particles, titanium oxide particles, and tin oxide particles.

7. The electrophotographic photoreceptor according to claim 6, wherein the metal oxide particles are zinc oxide particles.

8. The electrophotographic photoreceptor according to claim 5, wherein an amount of the metal oxide particles contained relative to the undercoat layer is 10 mass % or more and 80 mass % or less.

9. The electrophotographic photoreceptor according to claim 1, wherein the binder resin is at least one selected from the group consisting of a phenolic resin, a melamine resin, a guanamine resin, and a urethane resin.

10. A process cartridge detachable from and attachable to an image forming apparatus, the process cartridge comprising the electrophotographic photoreceptor according to claim 1, but not comprising a charge erasing unit that erases charges on a surface of the electrophotographic photoreceptor.

11. An image forming apparatus comprising:
at least two image forming units arranged side-by-side in a direction in which a transfer-receiving member travels, the image forming units each including
the electrophotographic photoreceptor according to claim 1,
a charging unit that charges a surface of the electrophotographic photoreceptor by a charging method involving applying a DC voltage,
an electrostatic latent image forming unit that forms an electrostatic latent image on the charged surface of the electrophotographic photoreceptor, and
a developing unit that develops the electrostatic latent image on the surface of the electrophotographic photoreceptor by using a developer containing a toner so as to form a toner image,
but not including a charge erasing unit that erases charges on the surface of the electrophotographic photoreceptor; and
a transfer unit that transfers the toner image onto a surface of the transfer-receiving member.
